(19) United States
(12) Patent Application Publication
(10) Pub. No.: US 2026/0014685 A1
(43) Pub. Date: Jan. 15, 2026

(54) REMOVAL DEVICE AND METHOD FOR REMOVING PARTS FROM MAIN BODY

(71) Applicant: IHI Corporation, Tokyo (JP)

(72) Inventor: Yutaka KAWANO, Tokyo (JP)

(73) Assignee: IHI Corporation, Tokyo (JP)

(21) Appl. No.: 19/331,006

(22) Filed: Sep. 17, 2025

Related U.S. Application Data
(63) Continuation of application No. PCT/JP2024/010095, filed on Mar. 14, 2024.

(30) Foreign Application Priority Data
Mar. 20, 2023 (JP) 2023-044647

(51) Int. Cl. B25B 27/02

(52) U.S. Cl. CPC B25B 27/02

(57) ABSTRACT

A removal device includes a first roller that is rotatable about a first axis and that comes into contact with an assembled product, a first shaft that rotatably supports the first roller about the first axis, and a base that moves the first shaft in a direction intersecting the first axis.

### CROSS REFERENCE TO RELATED APPLICATIONS

This application is a continuation application of International Application No. PCT/JP2024/010095, filed on Mar. 14, 2024, which claims priority to Japanese Patent Application No. 2023-44647 filed on Mar. 20, 2023, the entire contents of which are incorporated herein by reference.

### BACKGROUND ART

### Technical Field

The present disclosure relates to a removal device and a method for removing parts from a main body.

Various products may be assembled by engagement between a protrusion and a groove. For example, Patent Literature 1 discloses a disk assembly including a disk and a plurality of rotor blades. Each rotor blade includes a dovetail protruding from a base portion. Furthermore, the disk includes dovetail slots at positions where each rotor blade is mounted. Each rotor blade is assembled by inserting the dovetail into the dovetail slot.

### CITATION LIST

### Patent Literature

Patent Literature 1: EP 1288440 A

### SUMMARY

### Technical Problem

When a plurality of parts are attached to a main body by the above-mentioned engagement between protrusions and grooves, disassembly of such an assembled product may be time-consuming.

The present disclosure aims to provide a removal device and a method for removing parts from a main body which can reduce the time required to remove the parts from the main body.

### Solution to Problem

A removal device according to one aspect of the present disclosure includes a first roller that is rotatable about a first axis and that comes into contact with an assembled product, a first shaft that rotatably supports the first roller about the first axis, and a base that moves the first shaft in a direction intersecting the first axis.

A side surface of the first roller may include a tapered surface.

The removal device may include a second roller that is rotatable about a second axis and that comes into contact with the assembled product, the second roller being arranged opposite to the first roller across the assembled product and coming into contact with the assembled product from a side opposite to the first roller, a second shaft that rotatably supports the second roller about the second axis, a connecting plate that supports both the first shaft and the second shaft, and a main shaft that swingably supports the connecting plate so that the first roller and the second roller move toward the assembled product or move away from the assembled product across the assembled product and that is supported by the base.

The connecting plate may include at least one hole that supports the first shaft and the second shaft and that can adjust a distance between the first shaft and the second shaft.

A side surface of the second roller may include a tapered surface.

An elastic body may be interposed between the first shaft and the base.

When the removal device includes the main shaft, an elastic body may be interposed between the main shaft and the base.

A method for removing parts from a main body according to one aspect of the present disclosure includes preparing an assembled product that including a main body and a plurality of parts arranged on the main body along a first direction, each part being removable from the main body along a second direction intersecting the first direction, preparing a removal device including a first roller that is rotatable about a first axis, a first shaft that rotatably supports the first roller about the first axis, and a base that moves the first shaft in a direction intersecting the first axis, moving the assembled product along the first direction, and moving the base and applying a pressing force including a component in the second direction to each part by sequentially pressing the first roller against the plurality of parts that are moved in the first direction, and thereby removing each part from the main body.

### EFFECTS

According to the present disclosure, the time required to remove parts from a main body can be reduced.

### BRIEF DESCRIPTION OF DRAWINGS

FIG. 1 is a schematic side view showing a removal set including a removal device according to a first embodiment.

FIG. 2 is a perspective view showing an example of an assembled product.

FIG. 3 is a schematic front view showing the removal set in FIG. 1.

FIG. 4 is an enlarged view of area A in FIG. 3.

FIG. 5 is a schematic side view showing the removal set including a removal device according to a second embodiment.

FIG. 6 is a schematic illustration showing operation of a first roller and a second roller.

FIG. 7 is a schematic top view showing the removal set including a removal device according to a third embodiment.

### DESCRIPTION OF EMBODIMENTS

Embodiments of the present disclosure will be described in detail below with reference to the accompanying drawings. Specific dimensions, materials, and numerical values described in the embodiments are merely examples for a better understanding, and do not limit the present disclosure unless otherwise specified. In this specification and the drawings, duplicate explanations are omitted for elements having substantially the same functions and configurations by assigning the same sign. Furthermore, elements not directly related to the present disclosure are omitted from the figures.

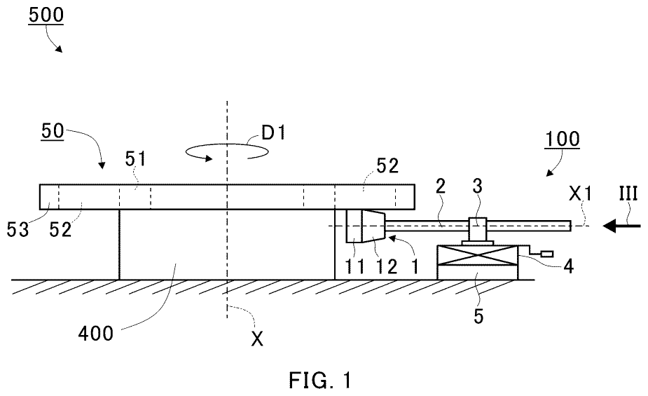

FIG. 1 is a schematic side view showing a removal set 500 including a removal device 100 according to a first embodiment. In the present disclosure, the removal set 500 and the removal device 100 may simply be referred to as the “set 500” and the “device 100,” respectively. In the present embodiment, the set 500 is used to sequentially remove a plurality of parts from a rotating assembled product 50.

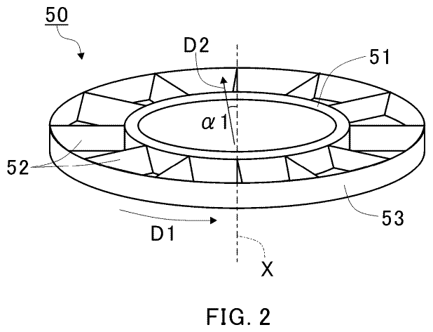

FIG. 2 is a perspective view showing an example of the assembled product 50. The assembled product 50 includes a main body 51 and a plurality of parts 52. For example, in the present embodiment, the assembled product 50 may be an impeller including a disk 51 as the main body and a plurality of blades 52 as parts. Additionally, for example, in the present embodiment, the assembled product 50 further includes an outer ring 53. The assembled product 50 may further include other components. Furthermore, in another embodiment, the assembled product 50 may not include the outer ring 53. The assembled product 50 is not limited to the impeller, and may be various products including a main body and a plurality of parts.

The main body 51 has an annular or cylindrical shape. The main body 51 has a central axis X. The outer ring 53 has an annular or cylindrical shape that is larger than the main body 51. The outer ring 53 is arranged coaxially with the main body 51. A space is defined between the main body 51 and the outer ring 53.

The parts 52 are attached to the main body 51. In the present embodiment, the part 52 are arranged in the space between the main body 51 and the outer ring 53, and are attached to both the main body 51 and the outer ring 53. The plurality of parts 52 are arranged on the main body 51 in a circumferential direction (first direction) D1 around the central axis X. Each part 52 extends radially outward from the main body 51 to the outer ring 53. In the example of FIG. 2, the assembled product 50 includes twelve parts 52. The number of parts 52 is not limited thereto, and the assembled product 50 may include various numbers of parts 52 (for example, the parts 52 may be 50 or more).

In the present embodiment, the parts 52 are detachably attached to the main body 51 and the outer ring 53. For example, the part 52 may be attached to the main body 51 and the outer ring 53 by engagement between a protrusion and a groove. In this case, for example, each part 52 may include a protrusion (e.g., dovetail) at both ends in an extending direction, and each of the main body 51 and the outer ring 53 may include grooves into which the protrusions are inserted. In another embodiment, each part 52 may include a groove at both ends in the extending direction, and each of the main body 51 and outer ring 53 may include projections that are inserted into the grooves.

The part 52 is configured to be attached to and detached from the main body 51 and the outer ring 53 along a second direction D2 that intersects the circumferential direction D1. In the present embodiment, the direction D2 is inclined with respect to the central axis X. In other words, in the present embodiment, the direction D2 and the central axis X define an angle al therebetween when seen in a radial direction of the central axis X. In another embodiment, the direction D2 may be parallel to the central axis X (α1=0). In this case, the direction D2 is perpendicular to the circumferential direction D1, and each part 52 is configured to be attached to and detached from the main body 51 along the direction D2 that is perpendicular to the circumferential direction D1.

Referring to FIG. 1, the set 500 includes the device 100 and a rotary table 400.

The rotary table 400 moves the parts 52 along the circumferential direction D1. In the present embodiment, the rotary table 400 supports one of end faces of the main body 51 such that the central axis X is set along a vertical direction. The rotary table 400 rotates the assembled product 50 about the central axis X. As such, the plurality of parts 52 are moved along the circumferential direction D1. For example, the rotary table 400 may be rotated hydraulically or by a motor, or may be rotated manually.

The device 100 includes a roller (first roller) 1, a shaft (first shaft) 2, a shaft rest 3, a base 4, and a magnet stand 5. The device 100 may further include other components. Furthermore, in another embodiment, the device 100 may not include at least one of the above components.

The roller 1 is rotatable about an axis (first axis) X1. For example, the axis X1 is set perpendicular to the central axis X of the assembled product 50. In the present embodiment, the axis X1 is set in a horizontal direction. Furthermore, in the present embodiment, the axis X1 is set perpendicular to the removal direction D2 (not shown in FIG. 1) of the parts 52. The roller 1 is configured to sequentially comes into contact with the plurality of parts 52 of the assembled product 50 (described in detail below).

In the present embodiment, the roller 1 includes a cylindrical surface 11 and a tapered surface 12. The cylindrical surface 11 has a cylindrical shape. The cylindrical surface 11 is intended to come into contact with the parts 52. The tapered surface 12 is formed continuously with the cylindrical surface 11. A diameter of the tapered surface 12 decreases as it moves away from the cylindrical surface 11. The maximum diameter of the tapered surface 12 is equal to the diameter of the cylindrical surface 11. The tapered surface 12 is not intended to come into contact with the parts 52. By forming the tapered surface 12, it is possible to secure a support area of the roller 1 by the shaft 2 while limiting an area where the roller 1 comes into contact with the part 52. Accordingly, for example, it is possible to avoid contact between the roller 1 and an easily deformable portion in the part 52.

As described later, when a skateboard truck is used as the shaft rest 3, the roller 1 may be formed by machining a skateboard roller. In another embodiment, the roller 1 including the cylindrical surface 11 and the tapered surface 12 may be newly made.

The shaft 2 rotatably supports the roller 1 about the axis X1. In the present embodiment, the shaft 2 extends along the axis X1. However, the shaft 2 may extend obliquely to the axis X1 as long as it rotatably supports the roller 1 about the intended axis X1. For example, a bearing (not shown) may be arranged between the roller 1 and the shaft 2.

The shaft rest 3 supports the shaft 2. In the present embodiment, the shaft rest 3 supports a substantially center in the extending direction of the shaft 2.

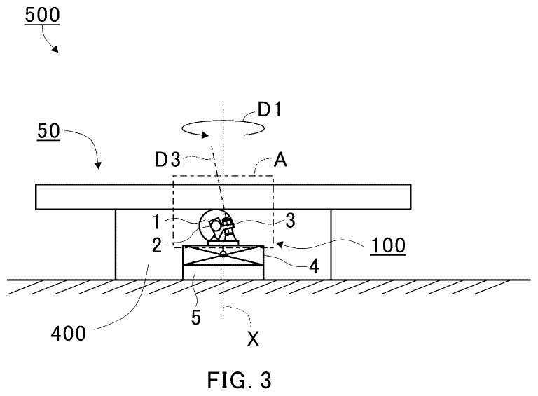

FIG. 3 is a schematic front view showing the removal set 500 in FIG. 1. FIG. 3 shows the set 500 as seen in a direction indicated by arrow III in FIG. 1. In the present embodiment, the shaft rest 3 supports the shaft 2 in a direction D3 that is inclined with respect to the central axis X and the vertical direction.

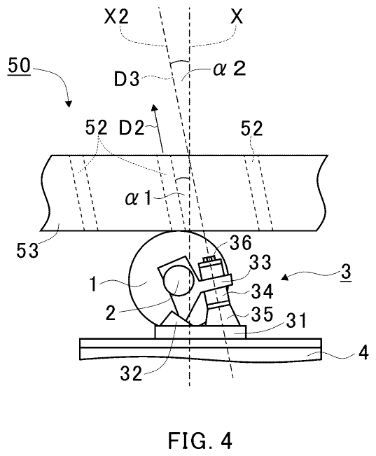

FIG. 4 is an enlarged view of area A in FIG. 3.

Specifically, in the present embodiment, a skateboard track may be used as the shaft rest 3. In this case, for example, the shaft rest 3 includes a base plate 31, a first bushing (pivot bushing) (elastic body) 32, a hanger 33, a second bushing (elastic body) 34, a third bushing (elastic body) 35, and a king nut 36. The shaft rest 3 may further include other components. Furthermore, in another embodiment, the shaft rest 3 may not include at least one of the above components.

The base plate 31 is fixed to an upper surface of the base 4. In the present embodiment, the base plate 31 is arranged in the horizontal direction. Accordingly, a perpendicular line of the base plate 31 is parallel to the vertical direction and the central axis X.

For example, the first bushing 32 has a substantially cylindrical shape. A lower part of the first bushing 32 is inserted into an unillustrated recess (cup) formed in the base plate 31 such that a central axis of the first bushing 32 is inclined with respect to the perpendicular line of the base plate 31.

The hanger 33 supports the shaft 2. The hanger 33 is supported by the first bushing 32, the second bushing 34, and the third bushing 35.

The second bushing 34 is inserted into a through hole formed in the hanger 33. For example, the second bushing 34 has a cylindrical shape or a cone shape. The third bushing 35 is arranged coaxially with the second bushing 34. The third bushing 35 has a cylindrical shape or a cone shape. A king pin (not shown) is inserted into the second bushing 34 and the third bushing 35. A bolt head of the king pin engages with a back side of the base plate 31. A king nut 36 is tightened on an end of the king pin. By adjusting the tightening force of the king nut 36, the flexibility of the second bushing 34 and the third bushing 35 can be adjusted. For example, by increasing the tightening force of the king nut 36, the second bushing 34 and the third bushing 35 become less deformable, and by decreasing the tightening force of the king nut 36, the second bushing 34 and the third bushing 35 become more deformable.

For example, the first bushing 32, the second bushing 34, and the third bushing 35 may include a resin having flexibility, such as rubber or polyurethane.

The above-described direction D3 in which the shaft rest 3 supports the shaft 2 corresponds to a direction in which a central axis X2 of the second bushing 34 and third bushing 35 extends. In the present embodiment, the central axis X2 is inclined with respect to the perpendicular line of the base plate 31 (i.e., the vertical direction and the central axis X). In other words, in the present embodiment, the central axis X2 and the central axis X define an angle α2 therebetween when seen in the radial direction of the central axis X. In another embodiment, a riser pad may be inserted between the base plate 31 and the upper surface of the base 4. By inserting the riser pad, the angle α2 can be adjusted.

For example, the direction D3 in which the shaft rest 3 supports the shaft 2 is aligned with or close to the removal direction D2 of the part 52. Accordingly, for example, if the direction D2 is parallel to the central axis X, the direction D3 may also be parallel to or substantially parallel to the central axis X (α2=0 or α2=0).

When a skateboard truck is used as the shaft rest 3, the shaft rest 3 is not limited to the above configuration, and various commercially available trucks may be used. For example, the shaft rest 3 may not include one of the second bushing 34 and the third bushing 35. Furthermore, commercially available tracks need not be used as the shaft rest 3, and the shaft rest 3 having a configuration similar to the above track may newly be made. In this case, for example, the shaft rest 3 may include at least a cylindrical member supporting the shaft 2 and an elastic body supporting the cylindrical member. The shaft rest 3 may further include other components.

Referring to FIG. 1, the base 4 supports the shaft rest 3. The base 4 moves the shaft 2 in a direction intersecting the axis X1. In the present embodiment, the base 4 moves the shaft 2 in a direction perpendicular to the axis X1. Specifically, in the present embodiment, the base 4 moves the shaft 2 in the vertical direction. As the shaft 2 is moved, the roller 1 is also moved in the same direction. For example, various commercially available jacks may be used as the base 4. Alternatively, commercially available jacks need not be used as the base 4, and the base 4 may newly be made that is configured to move in the intended direction. For example, the base 4 may be manually operated, or may be operated by a component such as a pneumatic cylinder, a hydraulic cylinder, or a combination of a motor and a ball screw.

The magnet stand 5 is fixed to a bottom of the base 4. For example, various commercially available magnet stands may be used. For example, the magnet stand 5 may be fixed to a face of a metal surface plate or the like. The device 100 can selectively be fixed on and released from the surface plate by turning the magnetism of the magnet stand 5 on and off.

Next, a method for removing the parts 52 from the main body 51 of the assembled product 50 using the device 100 will be described.

The assembled product 50 is set on the rotary table 400. Furthermore, the device 100 is set on the surface plate such that the cylindrical surface 11 of the roller 1 is positioned below an intended portion of the part 52.

Subsequently, the assembled product 50 is moved in the circumferential direction D1 by the rotary table 400. Furthermore, the base 4 is raised so that the roller 1 comes into contact with the parts 52. As a result, the roller 1 sequentially comes into contact with the plurality of parts 52 that are rotating, from a lower side.

Subsequently, by further raising the base 4, the

roller 1 is sequentially pressed against the plurality of parts 52 that are rotating. Referring to FIG. 4, since the direction D3 in which the shaft rest 3 supports the shaft 2 is aligned with or close to the removal direction D2 of the part 52, a pressing force including a component along the direction D2 is applied to each part 52. As a result, each part 52 loosens and is removed from the main body 51. The plurality of parts 52 are sequentially removed from the main body 51.

The device 100 as described above includes the roller 1 that is rotatable about the axis X1 and that comes into contact with the assembled product 50, the shaft 2 that rotatably supports the roller 1 about the axis X1, and the base 4 that moves the shaft 2 in the direction intersecting the axis X1. According to such a configuration, the pressing force can sequentially be applied to the plurality of parts 52 by moving the plurality of parts 52 in the direction (the circumferential direction D1 in the present embodiment) intersecting the movement direction of the base 4. Therefore, the plurality of parts 52 can sequentially be removed from the main body 51, thereby reducing the time required to remove the parts 52 from the main body 51.

Furthermore, in the device 100, the side surface of the roller 1 includes the tapered surface 12. By forming the tapered surface 12, it is possible to secure the support area of the roller 1 by the shaft 2 while limiting the area where the roller 1 comes into contact with the part 52. Accordingly, for example, it is possible to avoid contact between the roller 1 and an easily deformable portion in the part 52.

Furthermore, in the device 100, the first bushing 32, the second bushing 34, and the third bushing 35 are interposed between the shaft 2 and the base 4. Accordingly, these bushings can absorb shocks caused by intermittent contact between the roller 1 and the plurality of parts 52.

Furthermore, the method according to the present embodiment includes preparing the assembled product 50 including the main body 51 and the plurality of parts 52 arranged on the main body 51 along the circumferential direction D1, wherein each part 52 is removable from the main body 51 along the direction D2 intersecting the circumferential direction D1, preparing the device 100 including the roller 1 that is rotatable about the axis X1, the shaft 2 that rotatably supports the roller 1 about the axis X1, and the base 4 that moves the shaft 2 in the direction intersecting the axis X1, moving the assembled product 50 in the circumferential direction D1, moving the base 4 and applying the pressing force including the component in the direction D2 to each part 52 by sequentially pressing the roller 1 against the plurality of parts 52 that are moved in the circumferential direction D1, thereby removing each part 52 from the main body 51. According to such a configuration, the pressing force can sequentially be applied to the plurality of parts 52. Therefore, the plurality of parts 52 can sequentially be removed from the main body 51, thereby reducing the time required to remove the parts 52 from the main body 51.

Next, other embodiments will be described.

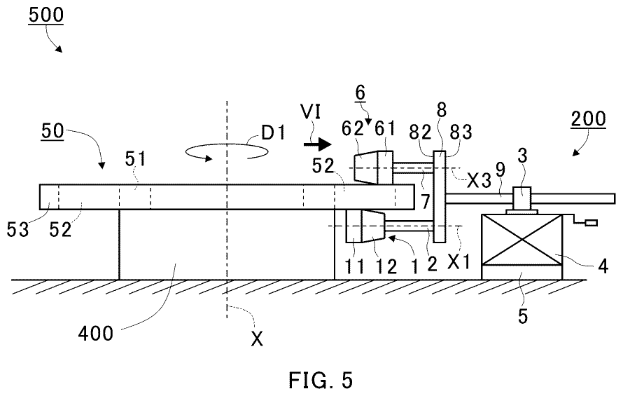

FIG. 5 is a schematic side view showing the removal set 500 including a removal device 200 according to a second embodiment. The device 200 differs from the device 100 according to the first embodiment in that the device 200 further includes a roller (second roller) 6, a shaft (second shaft) 7, a connecting plate 8, and a main shaft 9. For other configurations, the device 200 may be the same as the device 100.

The roller 6 is rotatable about an axis (second axis) X3. For example, the axis X3 is set perpendicular to the central axis X of the assembled product 50. In the present embodiment, the axis X3 is set in the horizontal direction. Furthermore, for example, the axis X3 is set perpendicular to the removal direction D2 (not shown in FIG. 5) of the part 52. In the present embodiment, the axis X3 of the roller 6 is parallel to the axis X1 of the roller 1. The roller 6 is configured to sequentially come into contact with the plurality of parts 52 of the assembled product 50.

The roller 6 is configured to be arranged on an opposite side of the roller 1 across the assembled product 50. In the present embodiment, the roller 6 is arranged on the opposite side of the roller 1 in the vertical direction across the assembled product 50. In other words, the roller 6 is arranged above the assembled product 50. Accordingly, the roller 6 comes into contact with the assembled product 50 from the opposite side of the roller 1. In other words, in the present embodiment, the roller 6 comes into contact with the assembled product 50 from above. In the present embodiment, the lower roller 1 is arranged so as to come into contact with a radially inner portion of the part 52 with respect to the central axis X, and the upper roller 6 is arranged so as to come into contact with a radially outer portion of the part 52 with respect to the central axis X.

In the present embodiment, the roller 6 includes a cylindrical surface 61 and a tapered surface 62. The cylindrical surface 61 has a cylindrical shape. The cylindrical surface 61 is intended to come into contact with the parts 52. The tapered surface 62 is formed continuously with the cylindrical surface 61. A diameter of the tapered surface 62 decreases as it moves away from the cylindrical surface 61. The maximum diameter of the tapered surface 62 is equal to the diameter of the cylindrical surface 61. The tapered surface 62 is not intended to come into contact with the parts 52. By forming the tapered surface 62, it is possible to secure a support area of the roller 6 by the shaft 7 while limiting an area where the roller 6 comes into contact with the part 52. Accordingly, for example, it is possible to avoid contact between the roller 6 and an easily deformable portion in the part 52.

When a skateboard truck is used as the shaft rest 3, the roller 6 may be formed by machining a skateboard roller. In another embodiment, the roller 6 including the cylindrical surface 61 and the tapered surface 62 may be newly made.

The shaft 7 rotatably supports the roller 6 about the axis X3. In the present embodiment, the shaft 7 extends along the axis X3. However, for example, the shaft 7 may extend obliquely to the axis X3 as long as it rotatably supports the roller 6 about the intended axis X3. For example, a bearing (not shown) may be arranged between the roller 6 and the shaft 7.

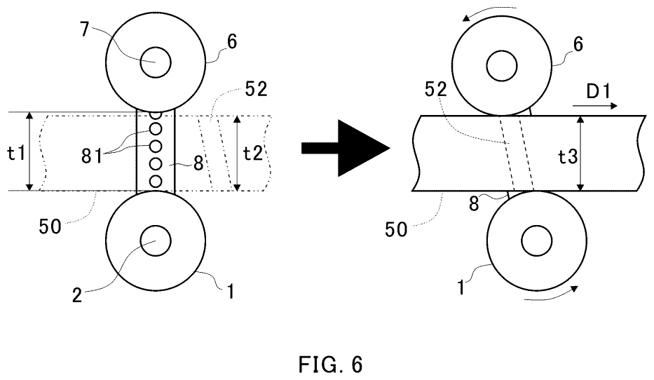

FIG. 6 is a schematic illustration showing operation of the first roller 1 and the second roller 6. FIG. 6 shows the roller 1, the roller 6, and the connecting plate 8 as seen in a direction indicated by arrow VI in FIG. 5. The left figure of FIG. 6 shows the roller 1, the roller 6, and the connecting plate 8 before the assembled product 50 is inserted, with the assembled product 50 indicated by dash-dot-dot lines. The right figure of FIG. 6 shows the roller 1, the roller 6, and the connecting plate 8 when the assembled product 50 is being moved.

The connecting plate 8 supports both the shaft 2 and the shaft 7. The connecting plate 8 has an elongated shape. In the present embodiment, the connecting plate 8 includes a plurality of through holes 81 along an extending direction. The through hole 81 has a circular shape. Each of the shaft 2 and the shaft 7 is inserted into and supported by one of the plurality of through holes 81. By changing at least one of the through holes 81 into which the shaft 2 and the shaft 7 are inserted, a distance between the shaft 2 and the shaft 7, i.e., a distance between the roller 1 and the roller 6, can be adjusted. In another embodiment, the connecting plate 8 may include one or more elongated holes instead of or in addition to the circular through holes 81. The elongated hole is formed along the extending direction of the connecting plate 8. In this case, the distance between the roller 1 and the roller 6 can be adjusted by changing at least one of positions of the shaft 2 and the shaft 7 within the elongated hole.

Referring to FIG. 5, the shaft 2 and the shaft 7 protrude from a first surface 82 of the connecting plate 8.

The main shaft 9 swingably supports the connecting plate 8. Accordingly, the connecting plate 8 is rotatable about the main shaft 9. As the connecting plate 8 rotates, the roller 1 and the roller 6 move toward the assembled product 50 or move away from the assembled product 50 across the assembled product 50. The main shaft 9 protrudes from a second surface 83 that is opposite to the first surface 82 in the connecting plate 8. In the present embodiment, the main shaft 9 is parallel to the shaft 2 and the shaft 7. The main shaft 9 is supported by the hanger 33 (not shown in FIG. 5) of the shaft rest 3.

Referring to the left figure of FIG. 6, when the connecting plate 8 is arranged perpendicular to the circumferential direction D1, i.e., when the connecting plate 8 is arranged parallel to the central axis X (not shown in FIG. 6) and the vertical direction, a gap t1 between the roller 1 and the roller 6 with respect to the part 52 (gap along the central axis X and the vertical direction) is set such that the gap t1 is slightly larger than a thickness t2 of the part 52.

Next, a method for removing the parts 52 from the main body 51 of the assembled product 50 using the device 200 will be described.

Referring to FIG. 5, the assembled product 50 is set on the rotary table 400. Furthermore, the device 200 is set on the surface plate such that the cylindrical surface 11 of the roller 1 is positioned below an intended portion of the part 52, and the cylindrical surface 61 of the roller 6 is positioned above an intended portion of the part 52.

Subsequently, the assembled product 50 is moved in the circumferential direction D1 by the rotary table 400. Furthermore, the base 4 is raised so that the roller 1 comes into contact with the parts 52. As a result, the roller 1 sequentially comes into contact with the plurality of parts 52 that are rotating, from a lower side.

Referring to the right figure of FIG. 6, as the assembled product 50 is moved in the circumferential direction D1 between the roller 1 and the roller 6, the assembled product 50 comes into contact with the lower roller 1. As described above, the connecting plate 8 is rotatable about the main shaft 9. Accordingly, although the roller 1 rotates as the assembled product 50 comes into contact with the roller 1, friction between the assembled product 50 and the roller 1 causes the connecting plate 8 to rotate. As a result, a gap t3 between the roller 1 and the roller 6 with respect to the part 52 decreases from the gap t1 shown in the left figure, and the parts 52 come into contact with both the roller 1 and the roller 6. In this state, a single part 52 receives an upward pressing force from the lower roller 1 while being supported downward by the upper roller 6. According to such a configuration, when the part 52 is removed from the main body 51, an attitude of the part 52 is maintained. Therefore, the part 52 is prevented from being stuck in the main body 51 due to the tilt of the part 52.

Subsequently, by further raising the base 4, the roller 1 is sequentially pressed against the plurality of parts 52 that are rotating. As such, the plurality of parts 52 are sequentially removed from the main body 51.

The device 200 as described above has similar effects to those of the device 100 according to the first embodiment. Furthermore, the device 200 includes the roller 6 that is rotatable about the axis X3 and that comes into contact with the assembled product 50, wherein the roller 6 is arranged opposite to the roller 1 across the assembled product 50 and comes into contact with the assembled product 50 from an opposite side of the roller 1, the shaft 7 that rotatably supports the roller 6 about the axis X3, the connecting plate 8 that supports both the shaft 2 and the shaft 7, and the main shaft 9 that swingably supports the connecting plate 8 such that the roller 1 and the roller 6 move toward the assembled product 50 or move away from the assembled product 50 across the assembled product 50 and that is supported by the base 4. According to such a configuration, when the part 52 is removed from the main body 51, the part 52 is pressed by one roller 1 while being supported in the opposite direction by the other roller 6. Therefore, the attitude of the part 52 is maintained, and the part 52 is prevented from being stuck in the main body 51 due to the tilt of the part 52.

Furthermore, in the device 200, the connecting plate 8 includes at least one hole (a plurality of circular through holes 81 in the present embodiment) that supports the shaft 2 and the shaft 7 and that can adjust the distance between the shaft 2 and the shaft 7. According to such a configuration, the device 200 can be used for removal of different parts 52 having different thicknesses.

Furthermore, in the device 200, the side surface of the roller 6 includes the tapered surface 62. By forming the tapered surface 62, it is possible to secure the support area of the roller 6 by the shaft 7 while limiting the area where the roller 6 comes into contact with the part 52. Accordingly, for example, it is possible to avoid contact between the roller 6 and an easily deformable portion in the part 52.

Although the embodiments of the present disclosure have been described above with reference to the accompanying drawings, the present disclosure is not limited thereto. It is obvious that a person skilled in the art can conceive of various examples of variations or modifications within the scope of the claims, which are also understood to belong to the technical scope of the present disclosure. Furthermore, the processes of the method of the above embodiments do not have to be executed in the above order, and may be executed in a different order as long as there is no technical inconsistency.

For example, in the above embodiment, the assembled product 50 is moved in a rotational direction, and the devices 100 and 200 are used to remove the parts 52 from the main body 51 of the rotating assembled product 50. In another embodiment, the assembled product may include a main body extending linearly in a predetermined first direction and parts arranged linearly on the main body along the first direction. In this case, the assembled product may be moved linearly in the first direction, and the devices 100 and 200 may be used to remove the parts 52 from the main body 51 of the assembled product 50 that moves linearly.

Furthermore, in the above embodiments, the rotary table 400 is configured to support the assembled product 50 such that the central axis X of the assembled product 50 is set in the vertical direction, and the roller 1 is configured to contact the parts 52 from a lower side so as to press the parts 52 upward. In another embodiment, the rotary table 400 may be configured to support the assembled product 50 such that the central axis X of the assembled product 50 is set in the horizontal direction, and the roller 1 may be configured to contact the parts 52 in the horizontal direction so as to press the parts 52 in the horizontal direction.

Furthermore, in the device 100 of FIG. 1, the roller 1 comes into contact with the assembled product 50 from a lower side, and is raised by the base 4. In another embodiment, the roller 1 of the device 100 may come into contact with the assembled product 50 from above, and may be lowered by the base 4. In this case as well, the parts 52 can be removed from the main body 51. Furthermore, in the device 200 of FIG. 5, the roller 1 and the roller 6 are raised by the base 4. In another embodiment, the roller 1 and the roller 6 of the device 200 may be lowered by the base 4. In this case as well, the parts 52 can be removed from the main body 51.

Furthermore, in the above embodiments, the devices 100 and 200 include the magnet stand 5. In another embodiment, for example, a rubber sheet having a high coefficient of friction may be fixed to the bottom of the base 4, instead of the magnet stand 5. In this case, in order to improve stability, a larger base 4 may be used compared to the case in which the magnet stand 5 is used.

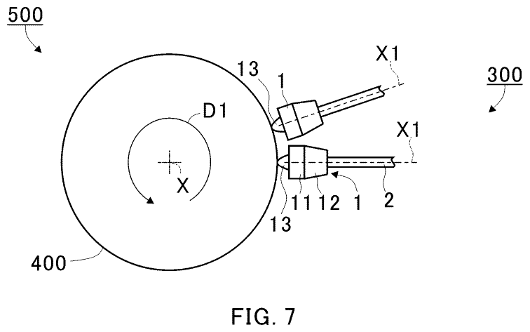

FIG. 7 is a schematic top view showing a removal set 500 including a removal device 300 according to a third embodiment. In FIG. 7, some components are omitted for better understanding. The device 300 differs from the device 100 according to the first embodiment in that the device 300 includes a plurality of first rollers 1 and each first roller 1 includes a positioning protrusion 13. For other configurations, the device 300 may be the same as the device 100.

In the above embodiment, the devices 100 and 200 have one first roller 1. In the present embodiment, the device 300 has two first rollers 1. The number of first rollers 1 is not limited to two, and may be three or more. For example, the plurality of first rollers 1 may be arranged along a direction (fourth direction) perpendicular to the direction in which the base 4 moves the shaft 2 (third direction). In the present embodiment, the plurality of first rollers 1 are arranged along the horizontal direction. In the present embodiment, the plurality of first rollers 1 are arranged along the circumferential direction D1. Specifically, in the present embodiment, the plurality of first rollers 1 are arranged such that the axis X1 of each first roller 1 passes through the central axis X. In other words, the axes X1 of the plurality of first rollers 1 intersect each other at the central axis X. A distance from the central axis X to the first roller 1 is the same for all the first rollers 1.

The positioning protrusion 13 protrudes toward the rotating table 400 from an end face of the roller 1 (cylindrical surface 11). The positioning protrusion 13 is intended to come into contact with the rotating table 400. For example, the positioning protrusion 13 may be formed from a resin having a low coefficient of friction. For example, the positioning protrusion 13 may be fixed to the end of the shaft 2. In this case, the positioning protrusion 13 does not rotate with the roller 1. Alternatively, the positioning protrusion 13 may be fixed to the end face of the roller 1. In this case, the positioning protrusion 13 rotates with the roller 1.

The device 300 as described above has similar effects to those of the device 100 according to the first embodiment. Furthermore, the device 300 includes the plurality of first rollers 1. According to such a configuration, falling of the removed part 52 can be avoided. Specifically, when only one first roller 1 is used, the part 52 lifted by the first roller 1 may immediately fall. For example, when two first rollers 1 are used, the part 52 lifted by a former first roller 1 is immediately supported by a latter first roller 1. At the same time, the former first roller 1 lifts the next part 52. Accordingly, a state where two parts 52 are lifted simultaneously is formed. The inventor found that in this state, friction between the main body 51 and the part 52 increases, thereby preventing the falling of the part 52. The same applies to a case in which the number of first rollers 1 is three or more.

Furthermore, the device 300 includes the positioning protrusion 13. According to such a configuration, the positioning protrusion 13 can contact the rotary table 400 to set the first roller 1 at an intended position. Accordingly, positioning of the first roller 1 is easier.

Furthermore, referring to FIG. 1, for example, the base 4 may include a stopper (not shown) for restricting the movement of the shaft 1. For example, the stopper may restrict at least one of upward movement and downward movement. According to such a configuration, for example, damage to the assembled product 50 caused by excessive pressing of the roller 1 can be prevented.

What is claimed is:

1. A removal device comprising:
a first roller that is rotatable about a first axis and that comes into contact with an assembled product;
a first shaft that rotatably supports the first roller about the first axis; and
a base that moves the first shaft in a direction intersecting the first axis.

2. The removal device according to claim 1, wherein a side surface of the first roller includes a tapered surface.

3. The removal device according to claim 1, comprising:
a second roller that is rotatable about a second axis and that comes into contact with the assembled product, the second roller being arranged opposite to the first roller across the assembled product and coming into contact with the assembled product from a side opposite to the first roller;
a second shaft that rotatably supports the second roller about the second axis;
a connecting plate that supports both the first shaft and the second shaft; and
a main shaft that swingably supports the connecting plate so that the first roller and the second roller move toward the assembled product or move away from the assembled product across the assembled product and that is supported by the base.

4. The removal device according to claim 3, wherein the connecting plate includes at least one hole that supports the first shaft and the second shaft and that can adjust a distance between the first shaft and the second shaft.

5. The removal device according to claim 3, wherein a side surface of the second roller includes a tapered surface.

6. The removal device according to claim 4, wherein a side surface of the second roller includes a tapered surface.

7. The removal device according to claim 1, wherein an elastic body is interposed between the first shaft and the base.

8. The removal device according to claim 3, wherein an elastic body is interposed between the main shaft and the base.

9. The removal device according to claim 4, wherein an elastic body is interposed between the main shaft and the base.

10. The removal device according to claim 5, wherein an elastic body is interposed between the main shaft and the base.

11. The removal device according to claim 6, wherein an elastic body is interposed between the main shaft and the base.

12. A method for removing parts from a main body, the method including:
preparing an assembled product comprising a main body, and a plurality of parts arranged on the main body along a first direction, each part being removable from the main body along a second direction intersecting the first direction;
preparing a removal device comprising a first roller that is rotatable about a first axis, a first shaft that rotatably supports the first roller about the first axis, and a base that moves the first shaft in a direction intersecting the first axis;
moving the assembled product along the first direction; and
moving the base and applying a pressing force including a component in the second direction to each part by sequentially pressing the first roller against the plurality of parts that are moved in the first direction, thereby removing each part from the main body.
